(19) United States
(12) Patent Application Publication
(10) Pub. No.: US 2026/0155054 A1
(43) Pub. Date: Jun. 4, 2026

(54) SYSTEM AND METHOD FOR ON-DEMAND SCHEDULING AND ROUTING OF AIRCRAFT

(71) Applicant: The Belmont Group, Belmont, MA (US)

(72) Inventors: Anastasios Daskalakis, Belmont, MA (US); Lars Anderson, Loveland, CO (US); Steve Anderson, Liberty Lake, WA (US); Erin Bidwell, Zionsville, IN (US); Greg Comstock, Porto (PT); Rod Childers, Red Banks, MS (US); Brian S Huckaby, Loveland, CO (US); Johnathan Kimpton, Galloway, NJ (US); Kimberly J Sparrow, Santa Fe, NM (US)

(21) Appl. No.: 19/287,137

(22) Filed: Jul. 31, 2025

Related U.S. Application Data
(60) Provisional application No. 63/677,875, filed on Jul. 31, 2024.

(51) Int. Cl. G08G 5/80; G08G 5/265; G08G 5/34; G08G 5/59

(52) U.S. Cl. CPC G08G 5/80; G08G 5/265; G08G 5/34; G08G 5/59

(57) ABSTRACT

Systems and methods for dynamic flight path planning for aircraft within a nodal environment matrix including stacked mesh arrays of spatially defined nodes. An aircraft occupancy envelope around an aircraft operating within the nodal environment matrix may be determined based on information from connected flight systems and operators. A projected availability state of a node within the nodal environment matrix may be based on a predicted interaction of the aircraft occupancy envelope with the node, using a predicted trajectory of the first aircraft occupancy envelope. Dynamic flight path planning may be performed based on projected availability states of nodes.

### CROSS-REFERENCE TO RELATED APPLICATIONS

This application claims the benefit of U.S. Provisional Patent Application No. 63/677,875 filed Jul. 31, 2024, the entire contents of which are incorporated herein by reference.

### BACKGROUND OF THE DISCLOSURE

This disclosure relates generally to airspace management including, e.g., dynamic pathing and dynamic scheduling for aircraft. More particularly, this disclosure relates to a nodal environment matrix for dynamic path planning.

The following description sets forth numerous specific details such as examples of specific systems, components, methods, and so forth, in order to provide a good understanding of various exemplary embodiments of the techniques described herein for supporting airspace management including Advanced Air Mobility (AAM), Urban Air Mobility (UAM), and/or Dynamic Path Planning (DPP), such as via a Nodal Environment Matrix (NEM). It will be apparent to one skilled in the art, however, that at least some embodiments may be practiced without these specific details. In other instances, well-known components, elements, or methods are not described in detail or are presented in a simple block diagram format in order to avoid unnecessarily obscuring the techniques described herein. Thus, the specific details set forth hereinafter are merely exemplary. Particular implementations may vary from these exemplary details and still be contemplated to be within the scope of the present disclosure.

AAM is an emerging aviation ecosystem that leverages an array of innovative propulsion, airframe, and aircraft technologies that are enabling new opportunities for transportation in the National Airspace System (NAS). The aviation industry expects the advancement of these new technologies for autonomy, electrification, and flight characteristics will require new airspace management concepts, routes, and automation to maximize mobility in urban areas. This concept is often referred to as UAM. UAM encompasses a small subset of AAM concepts that primarily focus on air-taxi services to the public over densely populated cities, including regional airport transfer cases, and intra-regional or urban ferry operations. UAM poses several significant challenges to industry and government agencies as both parties seek to encourage AAM industry evolution and innovation while maintaining commercial aviation's excellent safety record.

One of the largest of these challenges is the integration of new UAM concepts and operations into the NAS. UAM operations are expected to predominantly occur in Class B and Class C airspace that surround the nation's busiest airports. Class B airspace is some of the most challenging in the NAS, as it often faces capacity constraints, fluctuating demand patterns, and stringent airspace requirements. In addition to these unique complexities, Class B and C airspace are often affected by other factors that are common to the NAS, such as convective weather, Temporary Flight Restrictions (TFRs), and workload limitations for additional air traffic control services.

In view of these challenges, exemplary embodiments disclosed hereby provide an operational concept and solution that enables collaborative, scalable, dynamic, efficient, and safe UAM operations in complex urban airspace. Additionally, exemplary embodiments disclosed hereby support Cooperative Operating Policies (COPs) that utilize real-time information-sharing technologies and a federated service network to coordinate and manage the shared airspace for UAM. Further, the exemplary embodiments support monitoring by Air Traffic Control (ATC) of AAM operations for the urban environment utilizing cooperative services while enabling self-government and management.

Additionally, as UAM operations become more readily accepted by the general community, the tempo of operations is expected to increase. As this pace increases, the techniques disclosed hereby, such as the NEM can be utilized to address the following critical gaps: (1) Dynamic route planning that considers changing environmental conditions, vehicle performance and endurance, harmonization with other routes, airspace congestion, and strategic deconfliction; (2) Dynamic scheduling to condition the flow of traffic for on-demand access to constrained resources and to minimize conflicts between vehicles with starkly different performance and control characteristics; (3) Integration of emergent AAM operations with legacy operations in low-altitude airspace and around major airports; and (4) Tools and methods to bridge the gap between current-day operations and future AAM operations by facilitating teaming and collaboration between human operators and the autonomous agents/technologies needed for AAM operations to scale.

Industry and government agencies such as the Air Force Work Project (AFWERX), The National Aeronautics and Space Administration (NASA), and the Federal Aviation Administration (FAA) have performed significant research into addressing the operational responsibilities, requirements, and functionalities required to implement some of the shared service concepts for UAM. However, one of the major questions left unanswered in existing UAM models is how best to design and implement a cooperative airspace management solution that facilitates shared service responsibilities while also providing the ability to strategically deconflict operations. Two existing competing UAM operations models have been identified: pre-defined, or “fixed”, airspace solutions using defined corridors, and dynamic “free-flight” based solutions, using automation systems to identify available route options.

In fixed airspace models, industry and government are expected to work together to create distinct UAM-only corridors or route structures. These corridors would provide passage through the airspace using routes with defined vertical and lateral boundaries. The corridor structure would be accessible to any UAM aircraft meeting the specified performance, communication, navigation, and surveillance (CNS) requirements. Within these corridors, ATC separation services are not expected to be available; therefore, separation would be maintained by UAM operators and pilots in command. In the structured corridor model, UAM operations would be more predictable and defined, leading to increased safety outcomes. Additionally, corridors also have a low cost of entry to establish initial infrastructure and requirements. However, defined corridors trade predictability for an inability to meet demand; limited numbers of fixed routes have less capacity than dynamically assigned routing approaches.

In dynamic or free-flight models, industry and government approaches create new automation systems on the ground, on board the aircraft, or utilize a hybrid approach to help facilitate aircraft routing and separation. One primary challenge in designing a free-flight UAM solution is the ability to communicate intent data to ATC, airspace coordinators (ACs), and other participating and non-participating aircraft within the given airspace. Currently, there is no consensus or community standards on how best to achieve and develop these types of systems.

NASA DPP research outlines the inputs, outputs, interfaces, and functions required for any dynamic-based solution. NASA's research lays the foundation for the goals, responsibilities, tasks, and qualities that any DPP system must implement. The NASA DPP framework in theory allows multiple different independent implementations to communicate with one another, providing they all follow the proposed framework of airspace rules. According to the DPP framework, any solution seeking to provide dynamic pathing and flight planning must be able to: (1) Create a flight path with the desired qualities of being feasible, deconflicted, harmonized, flexible, and optimal; (2) Monitor the progress of flight in a dynamic operating environment; (3) Support the user in evaluating the continued acceptability of the flight path in changing conditions; (4) Revise the flight path as needed to maintain the desired flight path qualities; and (5) Coordinate the flight path with airspace users and service providers.

For at least the reasons above, a need exists for airspace planning and management systems and methods that integrate with and incorporate structured airspace planning and management systems and predefined flight planning in conjunction with flexible DPP solutions, for a growing variety of air vehicles and flight path requirements and evolutions of the same.

### BRIEF DESCRIPTION OF THE EXEMPLARY EMBODIMENTS

In an aspect, the exemplary embodiments include a computer-implemented method for dynamic path planning. The method may include generating a first aircraft occupancy envelope around a first aircraft operating spatially within a nodal environment matrix. The nodal environment matrix may include a plurality of vertically stacked two-dimensional mesh arrays of spatially defined nodes. The method may further include determining a projected availability state of an individual node of the spatially defined nodes based on a predicted interaction of the first aircraft occupancy envelope with the individual node, using a predicted trajectory of the first aircraft occupancy envelope.

In an aspect, the exemplary embodiments include a computing system including a machine-readable storage medium, a network interface, and one or more processing devices. The machine-readable storage medium stores a set of instructions executable by the one or more processing devices. The instructions may include generating a first aircraft occupancy envelope around a first aircraft operating spatially within a nodal environment matrix. The nodal environment matrix may include a plurality of vertically stacked two-dimensional mesh arrays of spatially defined nodes. The instructions may further include determining a projected availability state of an individual node of the spatially defined nodes based on a predicted interaction of the first aircraft occupancy envelope with the individual node, using a predicted trajectory of the first aircraft occupancy envelope.

In an aspect, the exemplary embodiments include a non-transitory machine-readable medium having executable instructions to cause one or more processing units to perform a method. The method may include generating a first aircraft occupancy envelope around a first aircraft operating spatially within a nodal environment matrix. The nodal environment matrix may include a plurality of vertically stacked two-dimensional mesh arrays of spatially defined nodes. The method may further include determining a projected availability state of an individual node of the spatially defined nodes based on a predicted interaction of the first aircraft occupancy envelope with the individual node, using a predicted trajectory of the first aircraft occupancy envelope.

### BRIEF DESCRIPTION OF THE DRAWINGS

The described exemplary embodiments and the advantages thereof may best be understood by reference to the following description taken in conjunction with the accompanying drawings. These drawings in no way limit any changes in form and detail that may be made to the exemplary embodiments by one skilled in the art without departing from the scope of the exemplary embodiments.

To easily identify the discussion of any particular element or act, the most significant digit or digits in a reference number refer to the figure number in which that element is first introduced.

FIG. 1 illustrates an exemplary NEM system architecture according to some embodiments of the disclosure;

FIG. 2A illustrates exemplary nodal mesh array layers of a layered nodal mesh matrix according to the exemplary embodiments;

FIG. 2B illustrates an exemplary mesh matrix of nodes according to the exemplary embodiments;

FIG. 2C illustrates an exemplary set of data of a node according to the exemplary embodiments;

FIG. 3 illustrates various aspects of an exemplary AOE according to the disclosure;

FIG. 4 illustrates an exemplary block diagram for DPP and associated operations according to some aspects of the disclosure;

FIG. 5 illustrates exemplary inputs and outputs of an NEM DPP system according to the disclosure;

FIG. 6 illustrates data flow in an NEM DPP system according to the disclosure;

FIG. 7 illustrates an exemplary process flow for DPP according to the disclosure;

FIG. 8 illustrates a block diagram of an exemplary computing device according to the disclosure;

FIG. 9 illustrates an exemplary communications architecture according to the disclosure;

FIG. 10 illustrates a nodal occupancy versus time plot according to aspects of the disclosure; and

FIG. 11 illustrates exemplary grid designs according to the disclosure.

Various features, aspects, and advantages of the exemplary embodiments will become more apparent from the following detailed description, along with the accompanying drawings in which like numerals represent like components throughout the figures and detailed description. The various described features are not necessarily drawn to scale in the drawings but are drawn to aid in understanding the features of the exemplary embodiments.

The headings used herein are for organizational purposes only and are not meant to limit the scope of the disclosure or the claims. To facilitate understanding, reference numerals have been used, where possible, to designate like elements common to the figures.

### DETAILED DESCRIPTION

The exemplary embodiments in this disclosure are directed generally to a nodal mesh structure—i.e., the NEM—to implement the DPP framework and, among other things, address the critical gaps and requirements identified above in a safe, reliable, and efficient manner. For example, the NEM according to an exemplary embodiment utilizes a mesh structure of nodes that can overlay any airspace, such as one designated for AAM operations. The NEM may include multiple stacked vertical layers of two-dimensional mesh arrays comprised of geographically and spatially defined nodes. Each layer of nodes may be vertically separated by applicable aircraft separation standards, or as otherwise required by ATC or local authorities. In addition to acting as assignable navigation waypoints, these nodes may act as data exchanges, sharing their predicted availability based on numerous criteria including predicted interaction with the AOEs of participating vehicles (e.g., UAM vehicles). This predicted interaction may be based on each aircraft's issued and monitored four dimensional trajectories. The NEM enables—among other things—a hybrid airspace management model that utilizes the best concepts from predefined, structured airspace solutions, along with dynamic route pathing flexibility typical of free-flight pathing solutions.

In these and other ways, components/techniques described hereby may provide many technical advantages for supporting airspace management in a safe, efficient, and reliable manner. Further, the techniques and features described hereby provide particular ways of programming or designing software to create a NEM for airspace management. Additionally, the techniques and features provide a specific interface and implementation for navigating and configuring complex interactions with a multitude of entities and resources in a centralized and efficient manner using techniques unique to computers. Therefore, the computer-based techniques of the current disclosure improve the functioning and capabilities of computer-based airspace management systems, resulting in better performance, improved capabilities, and improved user experiences as compared to conventional approaches. Accordingly, embodiments disclosed hereby can be practically utilized to improve the functioning of a computer and/or to improve a variety of technical fields including airspace management, graphical user interfaces, air traffic control, data sharing, dynamic path planning, data sharing,

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

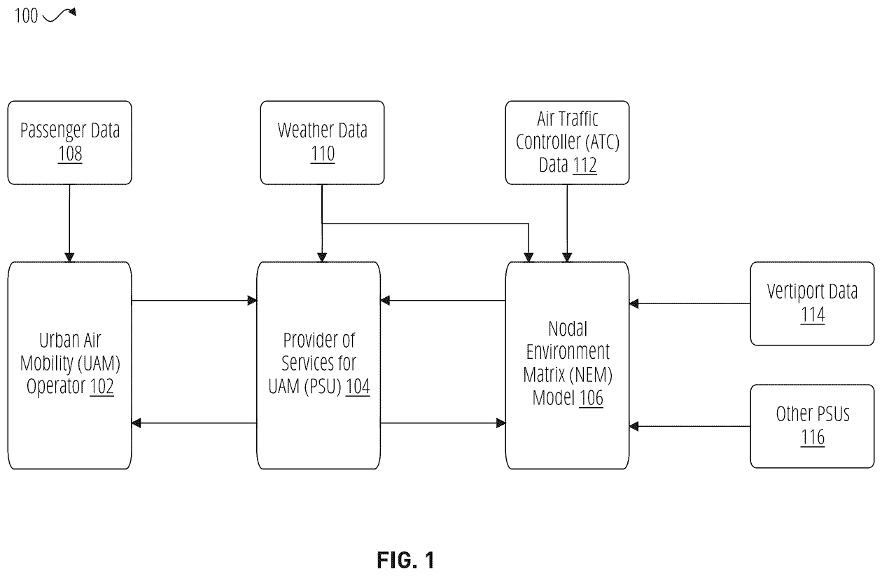

FIG. 1 illustrates an exemplary NEM system architecture 100 according to some embodiments. The illustrated embodiment includes various components that may be utilized to realize an NEM DPP system described hereby. The illustrated embodiment includes a UAM operator 102, a Provider of Services for UAM (PSU) 104, a NEM model 106, passenger data 108, weather data 110, ATC data 112, vertiport data 114, and one or more other PSUs 116. Embodiments are not limited in this context.

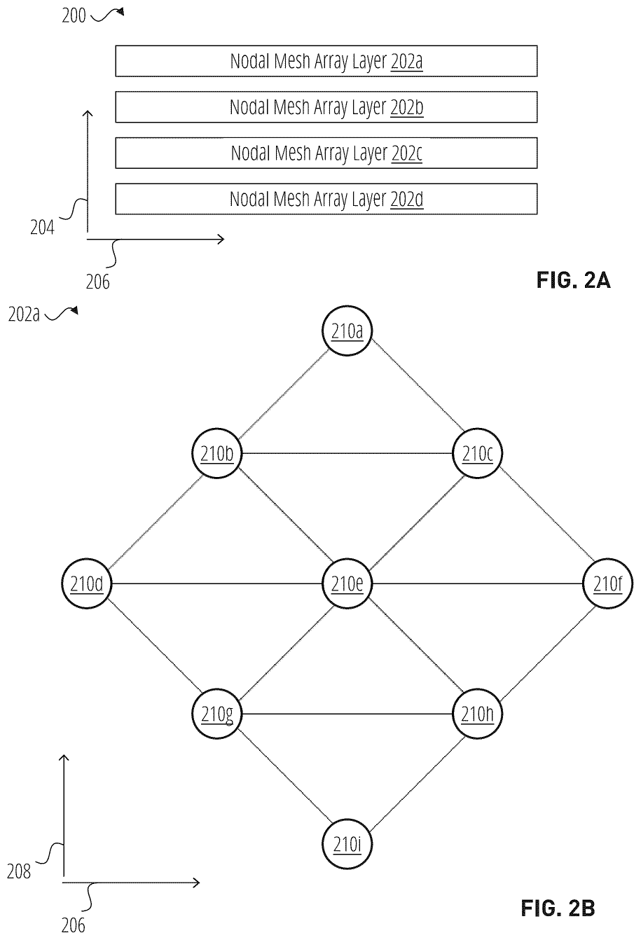

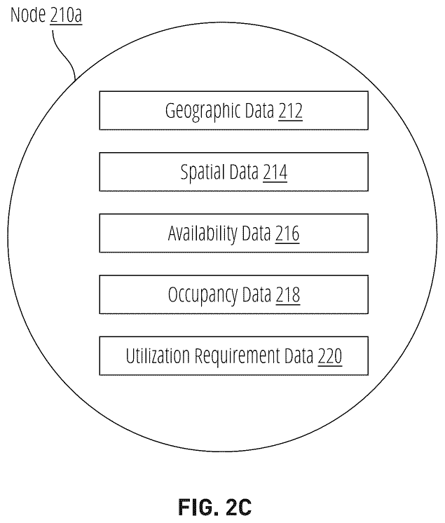

The NEM or NEM model 106 may utilize a mesh structure of nodes that can overlay any airspace designated for AAM operations. The NEM may include multiple stacked vertical layers of two-dimensional mesh arrays (see, e.g., FIGS. 2A and 2B) comprised of geographically and spatially defined nodes. Each layer of nodes may be vertically separated by applicable aircraft separation standards, or as otherwise required by ATC or local authorities. In addition to acting as assignable navigation waypoints, these nodes may act as data exchanges, sharing their predicted availability based on numerous criteria-most importantly predicted interactions with AOEs of participating UAM vehicles. An AOE is a form of containment radius, as discussed in more detail below. This interaction may be based on each aircraft's issued and monitored four-dimensional trajectories. The nodal matrix enables a hybrid airspace management model, utilizing—among other things—the best concepts from predefined, structured airspace solutions, along with dynamic route pathing flexibility typical of free-flight pathing solutions.

The NEM may include two components that work together to generate strategic deconfliction solutions that provide safety and efficiency. The first component of the NEM is a multi-layered nodal mesh matrix (see e.g., FIGS. 2A-2C), which may be centered around the related concepts of “nodal availability” and “nodal occupancy.” Nodal availability may be a metric that the NEM uses to determine if a node can be included in path planning and routing solutions. In some embodiments, each node will only have two possible states: open or closed. The availability of nodes in the system may be managed both dynamically (through automation), and by using fixed predetermined node state definitions. A node may be assigned a predetermined fixed state by ATC or ACs based on a known airspace configuration. Predefined corridors may be adapted within the NEM by configuring set nodes inside of the designated corridor as available, and nodes outside the corridor as unavailable. In addition to its use in designing predetermined fixed airspace corridors, static node (non)availability can be used to reflect permanent hazards such as terrain, and restricted airspace, or to satisfy local agreements. Dynamic nodal availability may be generated by the NEM (for each non-static node) based on flight pathing and time. Dynamic availability may be calculated using 4-D trajectory predictions for filed flight paths using an aircraft's AOE, as described in more detail below. If calculations suggest a node currently is or will be occupied by an aircraft, the node may be assigned an occupied state and/or marked as unavailable for that period, and NEM pathing algorithms will not use it for flight planning or dynamic flight pathing solutions.

The NEM's ability to use multiple layers of node arrays provides both flexibility and scalability to accommodate a wide variety of UAM use cases. In geographically constrained urban areas, adding additional vertical layers can allow for increased capacity and additional flight pathing options. Additionally, individual nodal layers may have related participation requirements, such as grouping aircraft by similar performance characteristics (e.g., slow and fast layers). Another use may be to vertically separate opposite-direction corridors in narrow bottleneck areas to minimize conflicts. These layer restrictions may be semi-permanent or variable (such as with differing directional demand based on time of day). The flexibility and scalability of these layers allow for differing adaptations based on specific local needs.

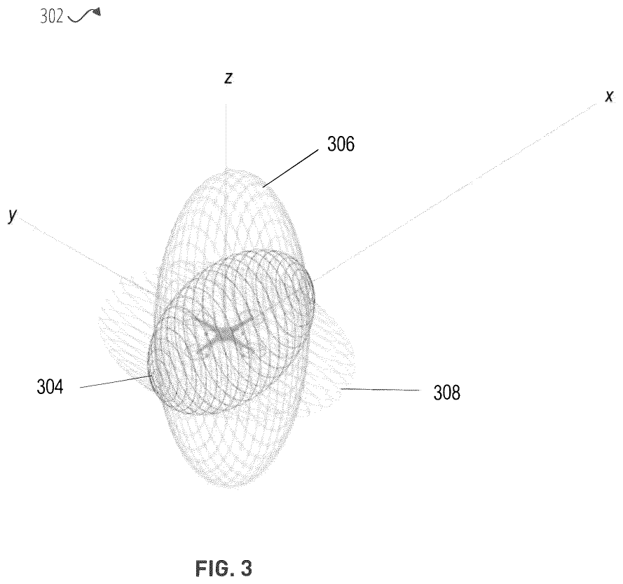

The second component of the NEM is referred to as the AOE, which is a risk-based metric similar in style to a Containment Radius (Rc) in position calculations. The AOE may be an ellipsoid shaped spatial envelope (see e.g., FIG. 3) used to determine a dynamic “no-fly” zone around an aircraft during active flight operations. AOE radial dimensions will never be less than applicable separation minima on any axis. AOE size and shape definitions can each be either static, or use heuristics such as aircraft maneuverability, performance parameters, fuel reserves, previous mission conformance, projected weather, communications, navigation, and surveillance system (CNS) equipage, or other factors to adjust the size and shape of each AOE in real time on an aircraft-by-aircraft basis. An aircraft's current and projected AOE interacts with the NEM's spatial node definitions to determine current and future nodal availability for all system users. During flight planning and dynamic flight pathing, the NEM system may compare an aircraft's predicted AOE trajectory against known node states to determine viable flight pathing solutions. The NEM system will reject proposed flight plans and reroute the aircraft utilizing unavailable nodes and offer the operator/flight planner an alternative solution based on a new departure time, different altitude layer or node set, or some combination thereof. Nodal availability and the AOE contribute substantially to enabling the NEM to provide strategic deconfliction and harmonized routes for all aircraft within UAM airspace.

Referring back to FIG. 1, the components of the NEM system architecture 100 may receive, identify, include, generate, and/or exchange various information to realize the techniques described hereby. Further, the inputs for one component may be utilized to generate outputs for another component. For example, passenger data 108 may include at least one of origin, destination, and preferred departure time data and the passenger data 108 may be provided to the UAM operator 102. The UAM operator 102 may provide data to the PSU 104, such as mission specification and parameters. Additionally, the UAM operator 102 may receive data from the PSU 104, such as confirmed operation details. The weather data 110 (or atmospheric information) may also be provided to the PSU 104. The PSU 104 may generate and provide a planned four-dimensional trajectory to the NEM model 106 based on the received inputs. Alternatively, the NEM model 106 may be responsible for the planned four-dimensional trajectory and have flight pathing and/or propagation algorithms built into the NEM model 106. In that case, the NEM model 106 may be a separate module exchanging information with the PSU 104, as shown in FIG. 1, or the NEM model 106 itself could act as a standalone PSU. As discussed further below, the NEM model 106 may take on different roles and architectures. For example, an NEM model that generates trajectories based on inputs may be an integrated NEM model and fulfill the role of a PSU. On the other hand, an NEM model that is operable primarily to accept or reject a trajectory may work in conjunction with a separate PSU. The ATC data 112 may include at least one of corridor definitions, airspace restrictions, temporary restrictions due to non-UAM operations, or approval crossing times for controlled airspace. The ATC data 112 may be provided to the NEM model 106. Similarly, the weather data 110 may be provided to the NEM model 106 along with vertiport data 114 and data from other PSUs 116. The vertiport data 114 may include vertipad availability and the data from the other PSUs 116 may include planned four-dimensional trajectories. Based on these inputs, the NEM model 106 may generate and provide availability likelihood of nodes in the NEM.

More generally, the NEM system, or NEM DPP system, may construct and maintain flight paths dynamically with the desired qualities based generally on five functions. These functions may be organized in terms of managing the flight paths with desired qualities, such as creating, monitoring, evaluating, revising, and coordinating flight paths which are feasible, deconflicted, harmonized, flexible, and/or optimal. The core functions of the NEM system may be supplemented by supporting functions including: modeling the mission objectives; modeling the operating environment; processing incoming data required by the NEM system; and processing outgoing data generated by the NEM system. The NEM system may also have the ability to configure its operational modes and interfaces in order to serve a potentially diverse array of AAM operations as well as to support variations in system hosting and user interactions. Further, the NEM system may include a mechanism to manage contingency events.

Modeling the flight path mission may include modeling an operator's mission objectives, which may be defined in terms of mission specification and mission parameters. Mission specification may include one or more of the origin, the destination, the desired departure and/or arrival times, and the selected aircraft type. Mission parameters may include elements that affect flight path generation, such as operator and passenger preferences, flight optimization criteria, flight path constraints, guidelines to address potential diversion contingencies, and available degrees of freedom for flight path planning.

Modeling the operating environment may include modeling the environment in which the flight path will be executed. The model may be defined in terms of the current and predicted data related to one or more of airspace, atmosphere, aerodromes, traffic, and hazards. Airspace information includes the applicable rules, structure, constraints, and community restrictions. Atmospheric (or weather) data may include one or more of winds, temperature, visibility, and atmospheric hazards to flight such as turbulence, convective weather, and icing. Aerodrome information may include one or more of operational configuration, arrival structure, terminal area restrictions and guidelines, schedule constraints, surface conditions, and refueling infrastructure status. Traffic information may include one or more of, for each aircraft in vicinity, its state, intent, conformance to intent, operational mode (e.g., applicable flight rules) and emergency status. Hazards (in addition to atmospheric hazards noted above) may include one or more of terrain, obstacles, special activity airspace, temporary flight restrictions, and any other known static and dynamic restricted areas.

Managing flight path feasibility may include planning and maintaining a flight path that conforms to the aircraft performance and/or range, complies with the airspace structure, rules, and/or constraints, and avoids the terrain and fixed, charted obstacles. This function may alert the user of potential infeasibility due to changes in operating environment, aircraft systems, or airspace constraints. It also may notify the user of constraints which needed to be relaxed by the NEM DPP system in order to maintain feasibility.

Managing flight path deconfliction may include planning and maintaining a flight path that does not, within an applicable time horizon, conflict with known traffic and other known, dynamic hazards. This function may alert the user of the detected conflicts, present relevant contextual information, and supply available resolution options. Managing flight path harmonization may include planning and maintaining a flight path that follows cooperative rules and procedures to ensure that use of the airspace is harmonized with other airspace users.

Managing flight path flexibility may include planning and maintaining a flight path which preserves adequate maneuverability to make future flight path changes, when necessary. This function may use configurable rules to define the factors that affect flexibility, such as robustness or adaptability to potential disturbances, and applicable thresholds for replanning. This function may alert the user of a degradation in predicted flight path flexibility that may signal added risk to mission completion.

Managing flight path optimality may include planning and maintaining a flight path which is optimal with respect to the criteria and constraints set by the fleet operator. This function may alert the user of a degradation in optimality and violation of optimization constraints. Managing flight path contingency may include identifying and responding to contingency events. It may include proactive responses to anticipated contingencies and/or reactive responses to those observed during the flight. This function may alert the user of the contingencies, and the methods used to mitigate their impact (e.g., relaxing a constraint, revising an optimization criterion). It also may alert the user of unresolved contingencies which may require user intervention.

Processing incoming information may include transforming the incoming data into useful information. The function may apply rules for data security, data decoding, data source selection, data loss, data latency, and/or data disposition. The function may alert the user of known instances of missing data, data parsing errors, and/or erroneous data. Processing outgoing information may include organizing and making available the system output to the users and external systems. The output data may include one or more of the planned flight path and its qualities, the predicted energy consumption profiles, and the contextual airspace, aerodrome and aircraft data. The function may also report the system health and other operational alerts to the users. Configuring system modes may include managing the modes of system operation, for monitoring health of system modules and databases, and/or for customizing rules for planning and maintaining acceptable flight paths. Configuring system interfaces may include managing interactive interfaces to the system users and automated interfaces to the operating environment.

In many embodiments, dynamic scheduling may be performed. Initial AAM operations are expected to be short urban routes with reduced flexibility, due to condensed airspace, and time and vehicle constraints. Additionally, UAM air taxi operators are expected to have less schedule predictability compared to conventional airline models. These limitations emphasize the need to create realistic, adaptable, and dynamic schedules to maximize the capacity and efficiency of these operations. To provide a realistic schedule, the dynamic scheduling solution must accommodate flexible departure windows as used in current NAS operations. Flexible departure windows allow a set threshold from the assigned departure time during which the operation can proceed with the approved flight plan. Allowing flexible scheduling windows provides for robust flight planning and avoids unrecoverable delays and missed opportunities, which create costs and inefficiencies. However, absent additional routing options, creating flexible schedules for the end user increases uncertainty as information such as exact timing over individual nodes is not known in advance, and aircraft compete for limited opportunities at bottlenecks such as track entry points.

One exemplary method to account for the uncertainty introduced by flexible scheduling may be to block all nodes within an approved flight plan for the duration of a set departure window. This method would ensure that the approved flight path remains deconflicted and harmonized. The NEM model could then update actual nodal availability (via the AOE and trajectory) once the aircraft is airborne and on track. However, this method requires nodes being blocked for longer periods, making them unavailable for other aircraft with competing scheduling requests. Fewer opportunities for other operators requesting operations with similar timing may lead to departure delays and underutilized nodes.

Another exemplary method to accommodate dynamic and flexible schedules may be to allow the NEM to overschedule individual nodal occupancy. Upon receiving a flight plan scheduling request, the NEM uses the operator's requested path and timing values (along with any locally adapted departure procedures) to generate a predicted trajectory. It uses this trajectory and the AOE to independently evaluate each node's availability, which it then shares with the end user. After evaluating nodal impact, the NEM could initially reject the request if one or more nodes in the requested flight plan show conflicting occupancy but allow the operator to override the rejected request-thus creating potential overlapping nodal occupancy. During periods of peak demand or rush hour traffic, some users may be willing to accept a route with a higher cancellation or confliction probability to achieve a more desirable departure time, creating potential conflicts that would need to be mitigated. The NEM scheduling algorithm may be configured to allow users to override rejected scheduling requests up to a set nodal occupancy value. The override limit value may stop any future schedule rejection override attempts for flight plans once any contained nodes reach a multiple nodal occupancy trigger point, such as 3× or 4× occupancy. These trigger points may be dynamically assigned, allowing the elimination of schedule rejection overrides entirely by reducing the trigger point occupancy to 1×. Even with this mitigation, however, the ability to override rejected flight plan requests will lead to an increased risk of conflicts which may require subsequent flight pathing revisions (or perhaps tactical deconfliction schemes).

The NEM offers multiple features that maximize alternate dynamic scheduling and pathing options—even in highly constrained airspace—thus preserving desired flexible departure scheduling for UAM air taxi operations, avoiding bottlenecks, and minimizing impacts to system efficiency. The NEM system may enable an initial defined airspace structure created within the stacked layer nodal mesh design. Creating a predefined nodal pathing structure/corridor via the NEM enables dynamic pathing deconfliction while allowing flexible routing options by providing a series of additional independent points and vertical layers that may be adapted for passing or overflow applications. In some embodiments, alternate dynamic path solution generation may be performed for scheduling requests that violate nodal occupancy. In various embodiments, dynamic flight rerouting and pathing may be performed to accommodate changing node availability during a mission.

The NEM by design is flexible and scalable to seamlessly transition to DPP along dynamically deconflicted nodal paths. The NEM may calculate the availability (e.g., state) of each node independently from all others and then share cumulative nodal availability with all participants currently using and requesting to use the airspace. Shared service awareness of current and future airspace availability may facilitate multiple interrelated solutions. The NEM design and the use of nodal availability may convey multiple restrictions and statuses for the airspace at a very granular level. Nodal availability can reflect current and future occupancy, current and future airspace restrictions, terrain hazards, weather conditions, as well as other temporary or permanent constraints. Consolidating and correlating all these constraints with their detailed geographic locations via individual nodes enables much simpler algorithms to coordinate and schedule operations. These cumulative nodal states define a shared unified airspace status that will allow the NEM to better strategically deconflict and harmonize all the operations within the airspace. The NEM generally provides an improved method and system for consolidating, updating, managing, and displaying airspace information at a granular geographic level because each individual node corresponds to a geographical location within the area defined by the NEM.

In some embodiments, nodal status definitions may include available/not available and occupied states and in addition a “restricted availability” state. For example, there may be many situations where the system needs to restrict, but not eliminate access to certain nodes. Some of these reasons could include noise abatement restrictions (e.g., requiring airframe noise reduction equipment), performance criteria (e.g., grouping high-speed and low-speed vehicles into separate tracks or layers), weather limitations (e.g., crosswinds or icing), or maximum number of vehicle operations per hour near sensitive areas. The NEM system has the ability to incorporate these restricted state values for affected nodes, allowing automated pathing calculations to ensure these nodes only are assignable to aircraft meeting the associated criteria.

In various embodiments, NEM system may act in an advisory role, where an operator or airspace coordinator enters their desired flight plan, and the NEM generates a simple accept or reject response. If a flight plan is accepted, the NEM updates nodal availability based on the newly accepted flight plan and resultant occupancy calculations. If a flight plan request is rejected, we expect the operator or AC to enter a new flight plan with updated parameters such as a different departure time, alternate altitude layer, or proposed pathing.

In many embodiments, the NEM may offer operators and ACs the option to simply enter their destination and mission parameters such as desired arrival or departure times, and preferred weighting criteria (e.g., fuel efficiency, eco-mode, shortest duration, etc.). Upon receiving these mission parameters, the NEM would offer the end user a set of pathing options to choose from. If none of the proposed solutions are acceptable, the NEM would allow the user to modify their parameters and submit a new request. Additionally, the opportunity for operators and ACs to be able to prioritize either route/altitude, or arrival time, creating two different types of NEM-generated solution sets may be provided by the system. If route or altitude is the priority, the NEM would generate only solutions incorporating the requested route/altitude, potentially at the cost of assigning additional departure delay. If arrival time is paramount, the NEM would offer solutions that prioritize arrival timing, potentially requiring a different route or altitude than originally requested. Certain mission criteria, such as maximum range or remaining battery life, would have to be respected in either type of solution set.

With the advancement of innovative technologies, AAM operations supported by NEM systems can utilize new airspace management concepts and routes to maximize mobility in urban areas. For example, urban operations are expected to predominantly occur in Class B and Class C airspace which is typically some of the nation's busiest. This airspace is especially challenging, as it often contains a mixture of Visual Flight Rules (VFR) and General Aviation (GA) aircraft as well as larger commercial Instrument Flight Rules (IFR) aircraft. The NEM system in many embodiments supports techniques to integrate other operations, such as legacy operations. For example, the different operation types may be segregated. For example, the NEM system may be utilized to create a new independent layer that provides a segmented section of airspace solely dedicated to these legacy operations. This could be accomplished by marking an entire vertical nodal mesh layer as unavailable for dynamic pathing algorithms and UAM operations. The definitions and availability of these legacy airspace layers can be coordinated with and communicated to legacy operators to maximize their practical usage. Further, new flight rules, such as Digital Flight Rules (DFR), or other air traffic management concepts can be developed and coordinated with ATC and the aviation community for this designated legacy airspace.

As the AAM ecosystem matures and operational tempo increases, the NEM system can support fully integrated legacy operations within the same UAM lateral and vertical airspace of the NEM. To fully integrate legacy operations, multiple different techniques may be implemented. For example, in low-tempo legacy operation areas, the use of transition zones or defined legacy routes within the NEM may be utilized. As mentioned previously, the NEM can use grouped nodal availability to define airspace corridors solely dedicated to legacy operations. Accordingly, agreed-upon legacy routes and corridors can be created as needed. These routes could be either temporarily restricted only when in use, or permanently set to unavailable for the NEM's UAM pathing algorithms to provide maximum access to non-UAM legacy aircraft. Another technique to support high-tempo operation areas is applying the AOE to legacy aircraft. In a mixed operating environment, the NEM system may generate AOEs around legacy aircraft as well, allowing the NEM to provide dynamic UAM pathing, scheduling, and separation from legacy operations. The AOE around a legacy aircraft may, for example, be much larger to better reflect their limited maneuverability. Additional networked communication technologies may be utilized to ensure sufficient information exchange between the UAM and legacy communities.

FIGS. 2A-2C illustrate various aspects of a layered nodal mesh matrix 200 according to some embodiments of the current disclosure. As shown in FIG. 2A, the layered nodal mesh matrix 200 may include one or more nodal mesh array layers 202a, 202b, 202c, 202d (collectively referred to as nodal mesh array layers 202) with an x-axis 206 and a z-axis 204. FIG. 2B illustrates an exemplary layout of nodal mesh array layer 202a, which may be the same or similar to the other nodal mesh array layers 202, with the x-axis 206 and a y-axis 208. As shown in FIG. 2B, the nodal mesh array layer 202a is comprised of a mesh matrix of nodes 210a-210i (collectively referred to as nodes 210). In some embodiments, the nodes of the different layers may be logically connected in a manner that is the same or similar to the nodes of the nodal mesh array layer 202a. Each of the nodes 210 may include and/or be defined by a set of data. As shown in FIG. 2C, this set of data may include geographic data 212, spatial data 214, availability data 216, occupancy data 218, and/or utilization requirement data 220. Embodiments are not limited in this context.

In various embodiments, parameter sweeps may be performed on the layered nodal mesh matrix 200 to determine parameter values. A parameter sweep is an iterative process in which simulations are repeated using different values for various parameters. Examples of values that could be evaluated in the parameter sweeps are the nodal spacings for the NEM grid design, separation minima for various use cases, and occupancy thresholds for nodal availabilities. Some existing techniques utilize cell-based designs with volumetric cells. However, by utilizing nodes instead of volumetric cells (or a polygonal instead of vertex definition), optimized and efficient airspace usage is ensured rather than sacrificing usable system capacity to duplicative separation.

FIG. 3 illustrates various aspects of an AOE 302 according to some embodiments of the current disclosure. The AOE 302 may be an ellipsoid shaped spatial envelope used to determine a dynamic “no-fly” zone around an aircraft during active flight operations. AOE 302 radial dimensions will never be less than applicable separation minima on any axis, x, y, or z. AOE 302 size and shape definitions can each be either static 304, or use heuristics such as aircraft maneuverability, performance parameters, fuel reserves, previous mission conformance, projected weather, communications, navigation, and surveillance system (CNS) equipage, or other factors to adjust the size and shape of each AOE in real time on an aircraft-by-aircraft basis. Embodiments are not limited in this context.

Referring to FIG. 3, time-dependent functions a(t), b(t), and c(t) may define a scaling of an ellipsoid along the axes. With c(t)>a(t) and/or c(t)>b(t), an ellipsoid 306 may be extended along the z-axis (representing a decreased vertical performance). In the case of c(t)<a(t) and/or c(t)<b(t), the ellipsoid 308 may be flattened, representing a comparatively good vertical performance in relation to horizontal performance. In some embodiments, dynamic expansion of the AOE 302 may be performed based on various input parameters such as convective weather, wind information, navigation or GPS interference, and position reporting errors. In some embodiments, the AOE 302 may be expanded in size during these types of events ensuring a more conservative scheduling approach to increase safety margins and decrease the risk of future tactical separation issues.

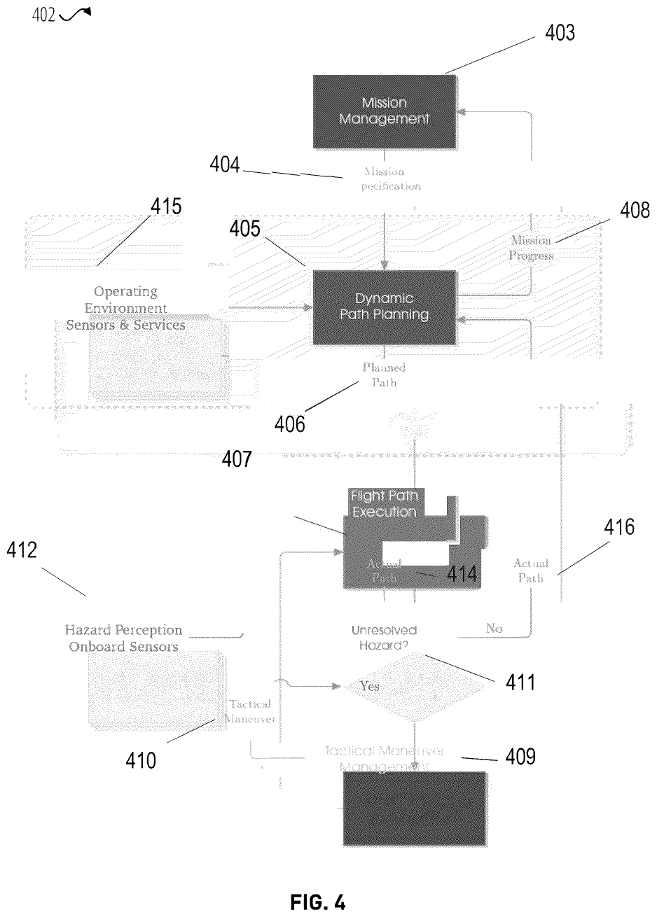

FIG. 4 illustrates an exemplary block diagram 402 for DPP and associated operations according to some embodiments. In various embodiments, DPP may include, or refer to, planning and updating an aircraft's flight path dynamically to meet the mission objectives and to account for the dynamic operating environment. The primary tasks of the NEM DPP system to manage a flight path may include: creating the flight path; monitoring the flight path and the factors which may impact it; evaluating ongoing acceptability of the flight path and proposed changes; revising the flight path, as needed, to sustain the desired qualities; and coordinating the flight path with other airspace users and service providers. In many embodiments, the NEM is utilized to improve performance of one or more of these tasks of DPP, such as via better data availability and situational awareness. Embodiments are not limited in this context.

The illustrated block diagram 402 highlights the role of the exemplary embodiments in the context of mission management, flight path execution, and tactical maneuver management. The block diagram 402 expects to receive a mission specification 404, and it develops and makes available a safe and operationally acceptable flight path to the users.

Mission Management 403 is generally concerned with real-time decision-making about the mission goals and objectives. It continually assesses mission completion feasibility, adjusts a mission specification 404 based on evolving conditions 408, and develops contingency and risk mitigation plans should the mission need to change substantially. While mission management functions may not manipulate the intended flight path directly, they may establish the objectives to be achieved and are therefore an executive input and oversight for DPP 405.

DPP 405 may support flight path decision-making within the boundaries of established (and potentially evolving) mission parameters. These functions can maintain awareness of airspace constraints, monitor for conflicts or other events that would compel a flight path change, and identify optimization opportunities within the established degrees of freedom. DPP system may re-plan the flight path 406 when warranted while ensuring safety, maintaining consistency with the mission objectives, and coordinating with other airspace users.

Tactical Maneuver Management 409 may be an independent layer of safety designed to detect and respond to near-term hazards 411 that are not predicted or otherwise non-conformant to established operational rules. Typically driven by independent sensors 412, these functions may produce guidance for a rapid response such as a tactical maneuver 410 to such hazards 411, overriding DPP 405 and suspending mission objectives until safety is restored. Afterward, DPP 405 may be invoked to reestablish the aircraft on a flight path 406 that recovers mission objectives.

Flight Path Execution 407 may address the execution of the planned flight path 406 but not its generation or modification. Its primary role relative to DPP 405 may be to achieve the expected navigation precision as may be required for certain encounters. Changes to vehicle performance that preclude the expected precision would be communicated 416 to DPP functions to assess the continued feasibility, and to account for the altered performance envelope.

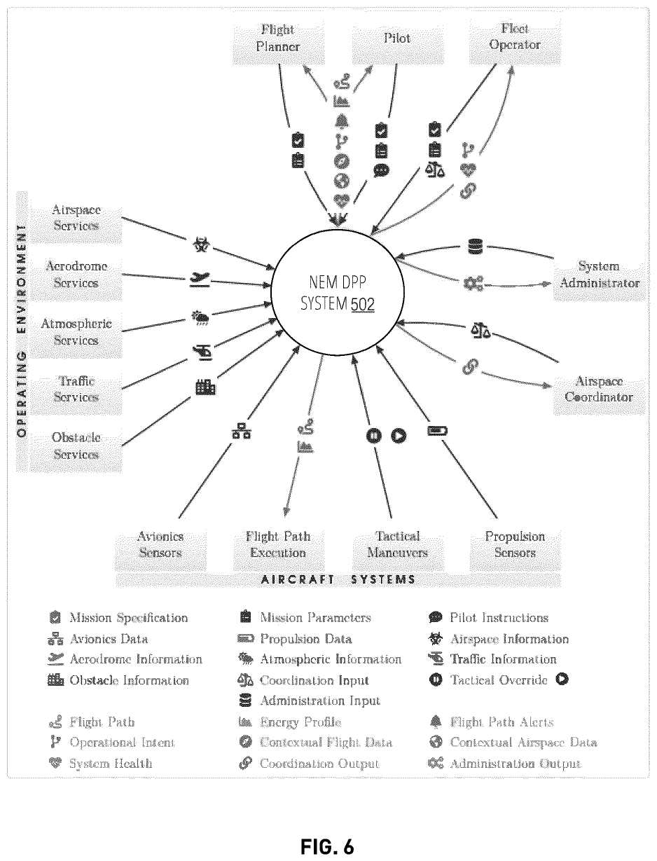

The flight paths may be required to adhere to various qualities and conditions. In many embodiments, the NEM may be utilized to support adherence to these qualities and conditions in an efficient and reliable manner. For example, the flight paths must be feasible, meaning that the aircraft must be able to fly them safely without violating performance envelope and available energy, airspace restrictions, fixed terrain and obstacles, and aerodrome procedures. Operating Environment Sensors and Services 415 may provide operating environment information (see FIG. 6) for the DPP 405. The consequence of an infeasible flight path may be rejection by the pilot, the flight path execution system, or the airspace authorities. In another example, the flight paths must be deconflicted up to a predefined time horizon against known traffic, restricted airspace, dynamic obstacles, and weather hazards, in order to ensure safety. Flight paths that remain conflicted are unsafe and may violate the operating rules of the flight. In another example, the flight paths may be harmonized with other airspace users and service providers, in order to enhance operational safety, capacity, efficiency, and equity. Unharmonized flight path changes may compromise these attributes and also violate the operating rules. In another example, the flight paths should offer flexibility by sustaining adequate maneuverability and anticipating typical contingencies with proactive flight path adjustments. A failure to sustain adequate flexibility and anticipate contingencies may occasionally compromise the ability to complete the intended mission. In another example, the flight paths should be optimal with respect to the operator's business goals and preferences. The absence of optimality may compromise the operator's business objectives and, for AAM aircraft with limited energy reserves, may impact the mission by cutting into the margins of already limited operational range. The optimal flight path may be constructed with respect to the optimization criteria and operational constraints assigned to the specific flight by the mission manager, taking system-level optimization into consideration.

As previously mentioned, the primary tasks of the NEM DPP system to manage a flight path may include: creating the flight path; monitoring the flight path and the factors which may impact it; evaluating ongoing acceptability of the flight path and proposed changes; revising the flight path, as needed, to sustain the desired qualities; and coordinating the flight path with other airspace users and service providers. Regarding creation, a mission specification may not specify a flight path to be flown. The NEM DPP system, therefore, must create a flight path with the desired qualities that satisfies the mission objectives. Regarding monitoring, safe and efficient flight operations in an increasingly complex and dynamic AAM operational environment means that a static flight path planned prior to departure may not be sufficient to ensure that it remains acceptable throughout the flight. The system, therefore, may monitor continually the aircraft state, the dynamic operating environment, and other unplanned events during the flight.

Regarding evaluating, as a result of monitoring the progress of the flight through the dynamic operating environment, the system may identify factors that impact the qualities of the planned flight path. The system may evaluate the impact of such events to the planned flight path for its continued safety and operational acceptability. The system may also be able to evaluate a candidate flight path proposed by a user. Regarding revising, if the flight path evaluation reveals a degradation in desired flight path qualities, the system may revise the flight path to ensure that it remains feasible, deconflicted, harmonized, flexible, and optimal throughout the flight. If necessary, the NEM DPP system must ensure that the qualities of the flight path related to safety are prioritized over the others. Depending on the operational concept employing DPP automation, the feasibility, deconfliction, and harmonization qualities may generally be considered more safety-critical than the flexibility and optimality qualities. Regarding coordinating, since flights operate in an airspace with other users, it is paramount that all computed flight paths—initial as well as revised—be in harmony with the operations of other users. The system, therefore, may coordinate the planned flight paths with applicable airspace and aerodrome users according to the procedures of the AAM operational concept.

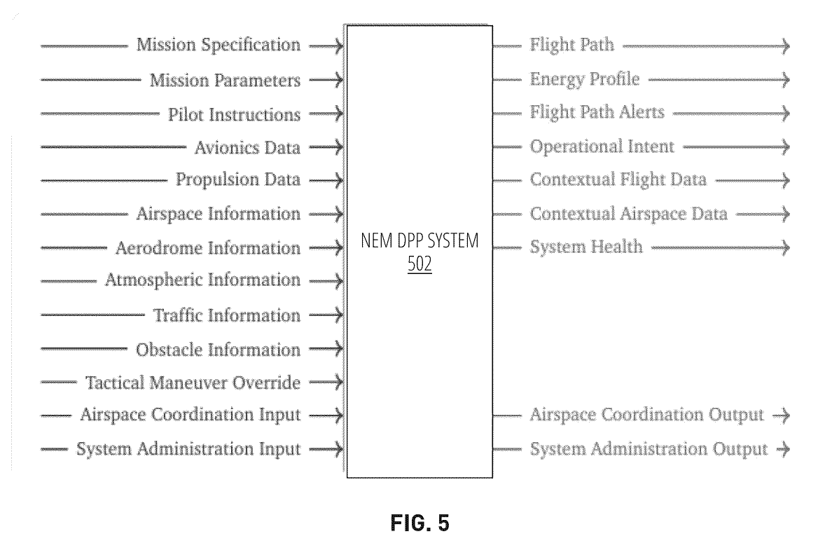

FIG. 5 illustrates exemplary inputs and outputs of an NEM DPP system 502 according to some embodiments of the current disclosure. Given the broad diversity of factors that influence the goals of flight path safety and operational acceptability for any given flight, the NEM DPP system 502 may utilize an extensive and diverse array of static and dynamic inputs. With additional reference to FIG. 6, these inputs may specify the mission, user preferences, aircraft capabilities, the operating environment, and constraints posed by the shared use of that environment. The outputs of the NEM DPP system 502 may be less diverse than the inputs. The primary outputs may include the computed flight path solution(s) and sufficient information to assist the stakeholders in verifying flight path acceptability, maintaining situation awareness, and/or preparing for flight path execution. Embodiments are not limited in this context.

Mission Specification 404 may include the origin, the destination, the desired departure and/or arrival times, mission type (passenger and/or cargo), and the selected aircraft type. This information may be fixed and supplied to the NEM DPP system 502 by the flight planner; however, the pilot may have the ability to change certain elements of the mission specification during the flight (e.g., a new destination).

Mission Parameters may include elements that affect flight path generation, such as operator and passenger preferences, flight optimization criteria, path constraints, rules to address potential diversion contingencies, and available degrees of freedom for flight path planning. This information may be supplied to the NEM DPP system 502 initially by the flight planner; the pilot may make changes to the mission parameters during the flight, if needed.

Pilot Instructions may include changes to mission specification 404 and mission parameters, flight path change inquiries, and/or decisions based on computed results (e.g., selection among multiple presented flight path options). An onboard pilot may interact with the system via a pilot interface, while a remote pilot may communicate instructions to the system via datalink. Avionics Data may include one or more of the current time; aircraft state data; aircraft navigation performance data; sensed weather, winds, and turbulence data; proximate traffic state and intent data; datalink messages from the ground systems; and the aircraft health data. The NEM DPP system 502 may receive this data automatically from respective aircraft sensors.

Propulsion Data may include the current propulsive energy available and the energy consumption rate. The data may also include propulsion specific parameters, e.g., the current or expected lift mode for eVTOL aircraft. An onboard NEM DPP system 502 may receive this data automatically from the relevant propulsion system interface, while an offboard NEM DPP system 502 may rely on an air-ground datalink to receive the data. Airspace Information may include one or more of airspace rules, the airspace structure in effect, and real-time status of special-activity and temporarily restricted airspace of relevance to the flight. The NEM DPP system 502 may rely on published airspace data and airspace information services for real-time updates to the data.

Aerodrome Information may include one or more of operational configuration, departure and arrival structure, takeoff and landing slot identification and availability, terminal area restrictions and guidelines, schedule constraints, surface conditions, and refueling, charging and maintenance infrastructure status. The NEM DPP system 502 may rely on an aerodrome service for this information. Atmospheric Information, or weather information, may include the current and forecast winds, temperatures, visibility, turbulence and other weather hazards of relevance to the flight. The NEM DPP system 502 may rely on atmospheric data services for this information.

Traffic Information may include the available intent of the aircraft currently flying or projected to be flying in the relevant airspace during the period of interest. Their conformance to the shared intent may also be provided, if available. These data complement the sensed data of the proximate traffic aircraft may be gathered by the onboard aircraft surveillance sensors in order to develop a complete and coherent picture of the expected traffic in the local airspace. The NEM DPP system 502 may rely on a traffic intent service for this information.

Obstacle Information may include the terrain map and real-time, dynamic obstacle data of relevance to the flight. The NEM DPP system 502 may rely on a terrain and obstacle identification services for this information. Airspace Coordination Input may include either a response from an airspace coordinator to the shared operational intent, or a request by an airspace coordinator and/or the fleet operator to consider a change to the flight path.

Tactical Maneuver Override may include commands to pause and resume dynamic path planning, as dictated by an aircraft tactical maneuver management system with presumed higher priority than the NEM DPP system 502. In some embodiments, an automated interface to receive an ‘override command’ from a tactical maneuver management system. System Administration Input may include configuration parameters related to one or more of the system capabilities, external interfaces, and user interactions. The NEM DPP system 502 may allow an administrator to interact remotely via a dedicated access-controlled administrative user interface.

Flight Path may be defined in terms of the aircraft latitude, longitude, and altitude as functions of time. It may also include the derived information such as the ground speed, vertical speed, and indications of flight path constraints on speed, time and altitude. The system may provide the flight path to the users and the aircraft flight path execution system. Energy Profile may be defined in term of the predicted energy usage required to meet the remainder of the mission as a function of time. It may also include the derived information like the energy available, rate of energy usage, and predicted reserves as functions of time. The system may provide the energy profile to the users and the aircraft flight path execution system.

Flight Path Alerts may include information designed to elicit the user's attention. These can include conflicts and other problems with the flight path detected during the process of path planning, as well as the anticipated and observed contingencies. The alerts may also offer the system's resolution of the identified issues and contingencies. The system may provide flight path alerts to the user displays. The system may also transmit any unresolved issues and contingencies to the fleet operator and/or the airspace coordinator.

Operational Intent may generally refer to an abridged version of the detailed flight path that may vary in content depending on its intended use. The system may inform the pilot of the operational intent, and may share it with an airspace coordinator and the fleet operator. Contextual Flight Data may include information about the mission, the aircraft, and the user preferences which were used in generating the flight path. It may also include one or more of the aircraft's current and predicted conformance to the intended flight path, energy profile, and constraints. The system may provide the contextual flight data to the pilot, and a relevant subset to the flight planner.

Contextual Airspace Data may include the airspace elements which influence the computed flight path, such as the airspace structure and rules, airspace hazards, atmospheric conditions, obstacles, aerodrome constraints, and/or traffic aircraft. The system may provide the contextual airspace data to the pilot, and a relevant subset to the flight planner. System Health may include the health of the components and interfaces of the system. The system may provide this information to its users, and may also inform the fleet operator and the administrator.

Airspace Coordination Output of the system may depend on the services available from an airspace coordinator. It may be a request to an airspace coordinator to coordinate the operational intent with other airspace users, or a response to a proposed flight path change from an airspace coordinator or fleet operator. System Administration Output may include the system health and response to the system administrator's commands. The NEM DPP system 502 may allow an administrator to interact remotely via a dedicated access-controlled administrative user interface.

FIG. 6 illustrates exemplary data flow between various entities and an NEM DPP system according to some embodiments of the current disclosure. For example, the exemplary NEM DPP system 502 shown in FIG. 5 is at the center of a significant influx of data and outflow of processed flight path solutions and supporting information. This extensive interchange is illustrated in FIG. 6, showing representative inputs, outputs, and the suite of data source systems and users that interact with the NEM DPP system 502. Embodiments are not limited in this context.

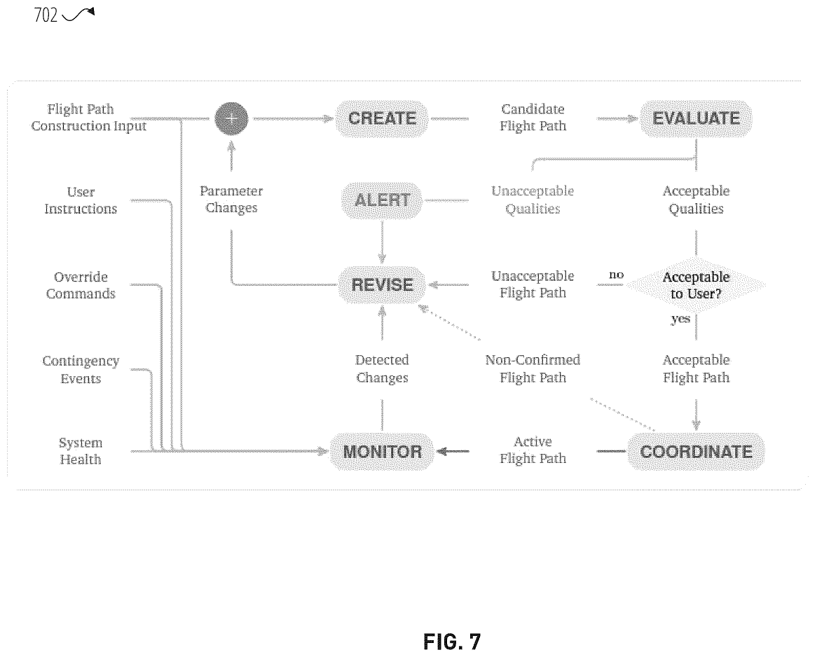

FIG. 7 illustrates a process flow 702 for DPP according to some embodiments of the current disclosure. The process flow 702 is organized in terms of creating, monitoring, evaluating, revising, and coordinating flight paths. As described above, the system may create an acceptable flight path, monitor the progress of the flight and the dynamic environment in which it operates, evaluate acceptability of the current and candidate flight paths, revise the flight path to restore or increase acceptability, and coordinate the flight path with other airspace users, possibly aided by an airspace coordinator. These tasks may be performed in support of interactive users and in response to change events. Embodiments are not limited in this context.

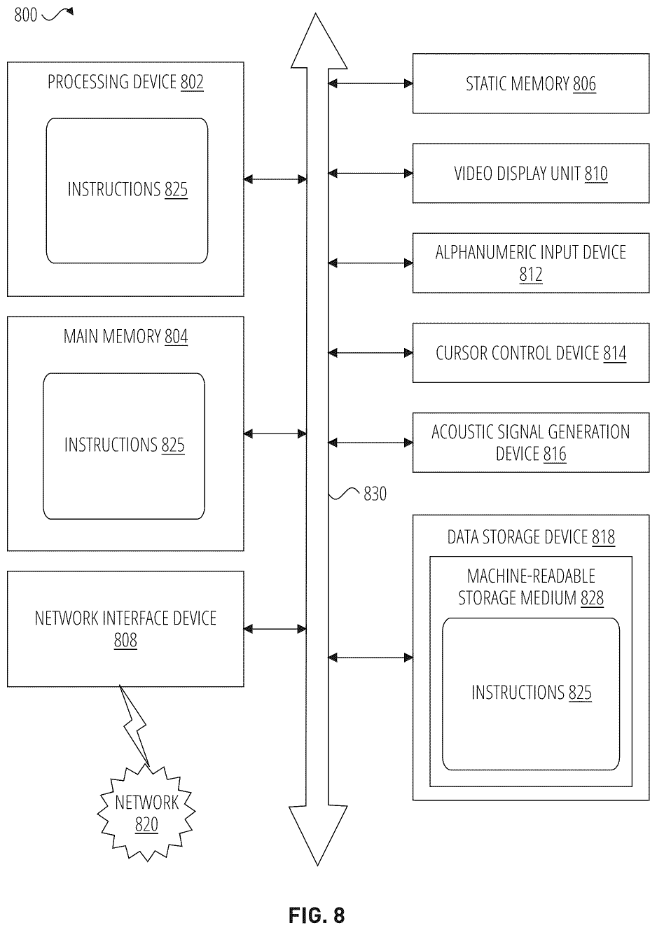

FIG. 8 is a block diagram of an example computing device 800 that may perform one or more of the operations described herein, in accordance with some embodiments of the disclosure. Computing device 800 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 800 may include a processing device 802 (e.g., a general purpose processor, a PLD, etc.), a main memory 804 (e.g., synchronous dynamic random access memory (DRAM), read-only memory (ROM)), a static memory 806 (e.g., flash memory and a data storage device 818), which may communicate with each other via a bus 830.

Processing device 802 may be provided by one or more general-purpose processing devices such as a microprocessor, central processing unit, or the like. In an illustrative example, processing device 802 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 802 may also include one or more special-purpose processing devices such as an application specific integrated circuit (ASIC), a field programmable gate array (FPGA), a digital signal processor (DSP), network processor, or the like. The processing device 802 may execute the operations described herein, in accordance with one or more aspects of the present disclosure, for performing the operations and steps discussed herein.

Computing device 800 may further include a network interface device 808 which may communicate with a network 820. The computing device 800 also may include a video display unit 810 (e.g., a liquid crystal display (LCD) or a cathode ray tube (CRT)), an alphanumeric input device 812 (e.g., a keyboard), a cursor control device 814 (e.g., a mouse) and an acoustic signal generation device 816 (e.g., a speaker). In one embodiment, video display unit 810, alphanumeric input device 812, and cursor control device 814 may be combined into a single component or device (e.g., an LCD touch screen).

Data storage device 818 may include a machine-readable storage medium 828 on which may be stored one or more sets of instructions 825 that may include instructions for a component (e.g., one or more components of nodal environment matrix system architecture 100, NEM DPP system 502, and/or NEM DPP system 602) for carrying out the operations described herein, in accordance with one or more aspects of the present disclosure. Instructions 825 may also reside, completely or at least partially, within main memory 804 and/or within processing device 802 during execution thereof by computing device 800, main memory 804 and processing device 802 also constituting computer-readable media. The instructions 825 may further be transmitted or received over a network 820 via network interface device 808.

While machine-readable storage medium 828 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that cause the machine to perform the methods described herein. The term “computer-readable storage medium” shall accordingly be taken to include, but not be limited to, solid-state memories, optical media, and magnetic media.

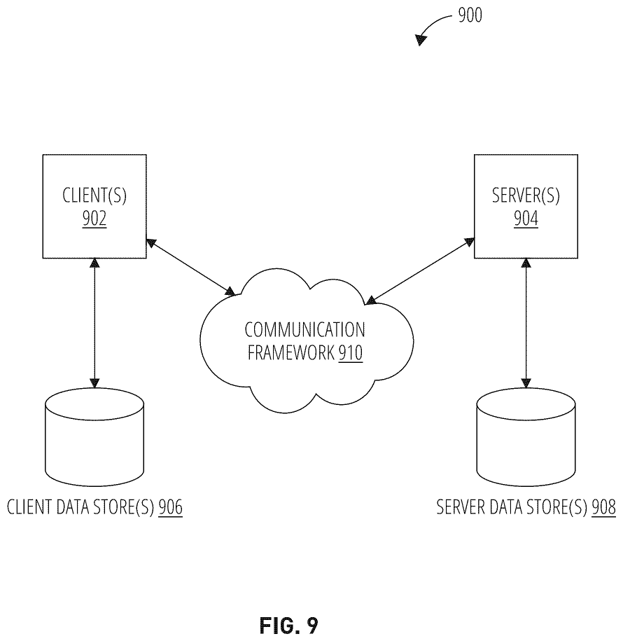

FIG. 9 is a block diagram depicting an exemplary communications architecture 900 suitable for implementing various embodiments as previously described, such as communications between one or more components of nodal environment matrix system architecture 100, for example. The communications architecture 900 includes various common communications elements, such as a transmitter, receiver, transceiver, radio, network interface, baseband processor, antenna, amplifiers, filters, power supplies, and so forth. The embodiments, however, are not limited to implementation by the communications architecture 900.

As shown in FIG. 9, the communications architecture 900 includes one or more client(s) 902 and server(s) 904. In some embodiments, each client 902 and/or server 904 may include a computing system (e.g., computing device 800). The server(s) 904 may implement one or more devices or components of one or more components of NEM system architecture 100, NEM DPP system 502, and/or NEM DPP system 602. The client(s) 902 may implement one or more device or components of user devices. The client(s) 902 and the server(s) 904 are operatively connected to one or more respective client data store(s) 906 and server data store(s) 908 that can be employed to store information local to the respective client(s) 902 and server(s) 904, such as cookies and/or associated contextual information. In various embodiments, any one of server(s) 904 may implement one or more logic flows or operations described hereby, such as in conjunction with storage of data received from any one of client(s) 902 on any of server data store(s) 908. In one or more embodiments, one or more of client data store(s) 906 or server data store(s) 908 may include memory accessible to one or more portions of components, applications, and/or techniques described hereby.

The client(s) 902 and the server(s) 904 may communicate information between each other using a communication framework 910. The communication framework 910 may implement any well-known communications techniques and protocols. The communication framework 910 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 910 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount of speed and capacity, distributed network controller architectures may similarly be employed to pool, load balance, and otherwise increase the communicative bandwidth required by client(s) 902 and the server(s) 904. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and the like.

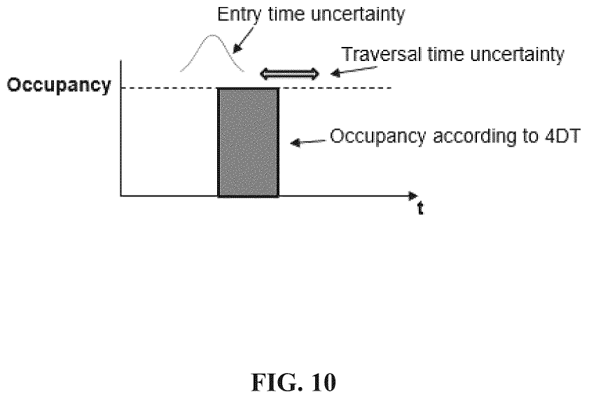

FIG. 10 shows a nodal occupancy versus time plot according to an aspect of the exemplary embodiments. The nodal occupancy at any given time or time period includes factors for entry time uncertainty and traversal time uncertainty.

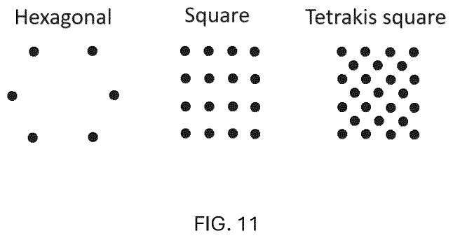

With reference to FIG. 11, exemplary NEM grid designs include, e.g., hexagonal, square, and tetrakis square designs. The exemplary grid designs may further be tiled to form the NEM. In an aspect and without limitation, nodes in the exemplary grid designs may be spaced every second of latitude and longitude, at a fixed distance based on minimum separation requirements, or with irregular spacing based on projected traffic density, based on, e.g., airspace efficiency, navigation suitability, system processing load, and human factors useability.

The exemplary embodiments of an NEM DPP system according to this disclosure and other embodiments not inconsistent with this disclosure including corresponding inputs, outputs, algorithms, calculations and the like, may further include, integrate, or incorporate machine learning and/or Artificial Intelligence (AI) components, systems, techniques, and the like. For example, the NEM and/or mesh matrix may create a defined framework that discretizes airspace for computer interaction and functions. This framework may provide a granular-level view of current and future airspace status for machine learning and AI-based tools (ML/AI) to use real-time data and historical data trends for—in whole or in part—dynamically optimizing the airspace for efficiency, capacity, and safety according to this disclosure. For example, in some embodiments ML/AI may be used for dynamic re-routing and/or pathing when an aircraft experiences a deviation off a planned route due to factors such as pilot error, weather, emergency conditions, etc.

In some embodiments, ML/AI may be used for schedule optimization based on aircraft routes, performance, characteristics, and nodal availability. Based on historical trends, the ML/AI may generate a flight density map (i.e., “heatmap”) of NEM nodes, determine where and when capacity bottle necks will likely occur (such as during rush hour), and schedule routes around those areas where possible. Accordingly, AI/ML enhances the role of each node as a data exchange to include ML/AI data input/output and provides additional features (such as a heatmap) to the NEM.

In some embodiments, ML/AI may be used for dynamic AOE scaling for an entire NEM implementation/geographical area. Based on various information being fed real-time by and through the NEM system—e.g., weather information, aerodrome status, flight plans—ML/AI may dynamically adjust AOEs for all vehicles in the airspace as required to account for shifting environmental conditions such as pop-up weather conditions, shifting wind, or other dynamic factors. Based on historical data, the ML/AI may determine the duration and degree of any real-time dynamic factors and the likely impacts or adjustments to AOEs throughout the airspace. Accordingly, ML/AI enhances the process of dynamically adjusting AOEs to include AOE adjustments for each vehicle in the airspace and models of overall adjustments on which individual adjustments may be based. Similarly, ML/AL may, based on historical trends and performance data, be used for dynamic AOE scaling for an individual aircraft. For example, if a certain aircraft routinely experiences course corrections and pilot deviations, ML/AI may identify this trend and correspondingly expand that aircraft's AOE to be larger than normal to avoid likely replanning for that aircraft.

In some embodiments, ML/AI may be used for collecting, organizing, and displaying—e.g., on dashboard displays—real-time data and detailed metrics for delivery/use with an Airspace Status Monitoring Graphical User Interface (ASM GUI). The ASM GUI provides a real-time visual depiction of the airspace. The ASM GUI may allow a user to toggle through each layer of the NEM according to this disclosure and display a real-time visualization of aircraft and nodes with the NEM along with current weather and restrictions in the airspace along with individual planned routes, and AOE sizes for selectable aircraft. The ML/AI may, for example, generate the specific visualizations, conditions, and metrics for the ASM GUI to display.

In some embodiments, ML/AI may assist an operator of the ASM GUI or the NEM system with flight planning. For example, ML/AI may suggest deconflicted paths given the current and future state of the system, based on current schedules and historical trends. Rather than, e.g., users providing a defined flight path they want to execute, operators may provide a departure, arrival, and constraints criteria (such as eco, comfort, fastest time, etc.) and the ML/AI may suggest routes. In some embodiments, the operator may either accept, modify, or reject the suggested routes.

Unless specifically stated otherwise, terms such as “generating,” “determining,” “calculating,” “modifying”, or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting. As used herein, the term “and/or” includes any and all combination of one or more of the associated listed items.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A computer-implemented method for dynamic path planning comprising:
generating a first aircraft occupancy envelope around a first aircraft operating spatially within a nodal environment matrix, wherein the nodal environment matrix includes a plurality of vertically stacked two-dimensional mesh arrays of spatially defined nodes; and
determining a projected availability state of an individual node of the spatially defined nodes based on a predicted interaction of the first aircraft occupancy envelope with the individual node, using a predicted trajectory of the first aircraft occupancy envelope.

2. The computer-implemented method of claim 1, wherein the step of generating the first aircraft occupancy envelope includes scaling the first aircraft occupancy envelope according to a time-dependent function based on a factor associated with the first aircraft.

3. The computer-implemented method of claim 1, wherein the predicted trajectory of the aircraft occupancy envelope is calculated using a four-dimensional trajectory prediction.

4. The computer-implemented method of claim 1, further comprising:
generating a second aircraft occupancy envelope around a second aircraft operating spatially within the nodal environment matrix;
determining a predicted trajectory of the second aircraft occupancy envelope;
comparing the predicted trajectory of the second aircraft occupancy envelope against the projected availability state of the individual node; and
generating a flight path for the second aircraft based on the predicted trajectory of the second aircraft occupancy envelope against the projected availability state of the individual node.

5. The computer-implemented method of claim 4, wherein the projected availability state of the individual node is an available state or an unavailable state, and the step of generating a flight path for the second aircraft includes utilizing the individual node in the available state or avoiding the individual node in the unavailable state.

6. The computer-implemented method of claim 1, further comprising updating a current availability state of the individual node to the projected availability state of the individual node, when the projected availability state is different from the current availability state.

7. The computer-implemented method of claim 6, further comprising revising a flight path of a second aircraft operating spatially within the nodal environment matrix, based on the projected availability state of the individual node.

8. The computer-implemented method of claim 1, further comprising:
generating an airspace corridor in the nodal environment matrix, wherein generating the airspace corridor includes assigning a current availability state of available to a first subset of the spatially defined nodes and assigning a current availability state of unavailable to a second subset of the spatially defined nodes, wherein the individual node is part of the first subset of nodes or the second subset of nodes; and
updating the current availability state of the individual node to the projected availability state of the individual node when the projected availability state of the individual node is different from the current availability state of the individual node.

9. The computer-implemented method of claim 8, further comprising revising a flight path through the airspace corridor to a flight path outside the airspace corridor for a second aircraft, based on the projected availability state of the individual node.

10. The computer-implemented method of claim 1, further comprising generating a flight density map of the nodal environment matrix based on historical data including airspace capacity data as a function of time, wherein determining the projected availability state of the individual node is based on the flight density map.

11. The computer-implemented method of claim 1, further comprising:
adjusting one of a first size and a first shape of the first aircraft occupancy envelope to a respective one of a second size and a second shape of the first aircraft occupancy envelope, based on real-time events; and
repeating the step of determining the projected availability state of the individual node, after the step of adjusting one of the first size and the first shape of the first aircraft occupancy envelope.

12. A computing system comprising a machine-readable storage medium, a network interface, and
one or more processing devices, the machine-readable storage medium storing a set of instructions executable by the one or more processing devices for:
generating a first aircraft occupancy envelope around a first aircraft operating spatially within a nodal environment matrix, wherein the nodal environment matrix includes a plurality of vertically stacked two-dimensional mesh arrays of spatially defined nodes; and
determining a projected availability state of an individual node of the spatially defined nodes based on a predicted interaction of the first aircraft occupancy envelope with the individual node, using a predicted trajectory of the first aircraft occupancy envelope.

13. The computing system of claim 12, wherein the set of instructions executable by the one or more processing devices include instructions for calculating the predicted trajectory of the aircraft occupancy envelope using a four-dimensional trajectory prediction.

14. The computing system of claim 12, wherein the set of instructions executable by the one or more processing devices include instructions for updating a current availability state of the individual node to the projected availability state of the individual node when the projected availability state of the individual node is different from the current availability state of the individual node, and transmitting the projected availability state of the individual node to a remote client via the network interface.

15. The computing system of claim 12, wherein the set of instructions executable by the one or more processing devices include instructions for receiving data related to a factor associated with the first aircraft from a remote client via the network interface and scaling the first aircraft occupancy envelope according to a time-dependent function based on the factor associated with the first aircraft.

16. The computing system of claim 12, wherein the set of instructions executable by the one or more processing devices include instructions for:
generating a second aircraft occupancy envelope around a second aircraft operating spatially within the nodal environment matrix;
determining a predicted trajectory of the second aircraft occupancy envelope;
comparing the predicted trajectory of the second aircraft occupancy envelope against the projected availability state of the individual node;
generating a flight path for the second aircraft based on the predicted trajectory of the second aircraft occupancy envelope against the projected availability state of the individual node; and
transmitting the flight path for the second aircraft to a remote client via the network interface.

17. A non-transitory machine-readable medium having executable instructions to cause one or more
processing units to perform a method comprising:
generating a first aircraft occupancy envelope around a first aircraft operating spatially within a nodal environment matrix, wherein the nodal environment matrix includes a plurality of vertically stacked two-dimensional mesh arrays of spatially defined nodes; and
determining a projected availability state of an individual node of the spatially defined nodes based on a predicted interaction of the first aircraft occupancy envelope with the individual node, using a predicted trajectory of the first aircraft occupancy envelope.

18. The non-transitory machine-readable medium of claim 17, wherein the method further comprises generating a second aircraft occupancy envelope around a second aircraft operating spatially within the nodal environment matrix;
determining a predicted trajectory of the second aircraft occupancy envelope;
comparing the predicted trajectory of the second aircraft occupancy envelope against the projected availability state of the individual node; and
generating a flight path for the second aircraft based on the predicted trajectory of the second aircraft occupancy envelope against the projected availability state of the individual node.

19. The non-transitory machine-readable medium of claim 17, wherein the predicted trajectory of the aircraft occupancy envelope is calculated using a four-dimensional trajectory prediction.

20. The non-transitory machine-readable medium of claim 17, wherein the method further comprises updating a current availability state of the individual node to the projected availability state of the individual node when the projected availability state of the individual node is different from the current availability state of the individual node.
